(19) United States
(12) Patent Application Publication
(10) Pub. No.: US 2007/0014512 A1
(43) Pub. Date: Jan. 18, 2007

(54) Torsional hinged MEMS device

(75) Inventor: Arthur Monroe Turner, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/481,370

(22) Filed: Jul. 5, 2006

Related U.S. Application Data
(60) Provisional application No. 60/696,866, filed on Jul. 5, 2005.

(51) Int. Cl. G02B 6/26

(52) U.S. Cl. 385/18

(57) ABSTRACT

A MEMS scanning system having a MEMS micro-mirror, the device having at least torsional hinge augmented by an applied elastomer element for the damping of excess ringing, and a method of making such a system. The scanning system may be an integral part of, for example, a high-speed optical communication network. In such a system, the MEMS micro-mirror device includes a micro-mirror layer, for example of silicon, from which the hinged micro-mirror is defined. After the torsional hinges are formed, the elastomer is applied and, if necessary, cured. The hinge structure itself may be configured in such a manner as to increase the efficacy of the augmenting elastomer.

This application claims the benefit of U.S. Provisional Application Ser. No. 60/696,866, filed on 5 Jul. 2005, entitled Increased Damping of Torsional Hinged Devices Using Elastomer Augmented Hinge Structures, which application is hereby incorporated herein by reference.

### TECHNICAL FIELD

The present invention relates generally to the field of MEMS devices, and relates more particularly to a MEMS scanning system having a micro-mirror rotatable on torsional hinges that are advantageously augmented by an elastomer element to promote more desirable system damping characteristics.

### BACKGROUND

A number of micro-electromechanical system (MEMS) devices are today being used for a variety of applications. As their name implies, these devices are often very small, and they are used in areas where their small size is an advantage. This advantage may arise because the appliance based on the MEMS operation, such as a television, is relatively small, or because a small device consumes less power, or is easier to transport than a larger device that may be otherwise able to perform the same function. Of course, in some cases the MEMS device may be able to deliver a better result altogether. Certainly, fewer materials are consumed in the fabrication of small system components process than would be required for larger devices, and by the same token there is less material to dispose of or recycle when the appliance has outlasted its usefulness. Fabrication of such small devices may be more difficult than with larger devices, but on the other hand they are often made using techniques similar to those originally developed for making solid state electronics devices, frequently by the same companies, meaning that the facilities for their construction are already largely in place and useful for manufacturing other products as well.

Another advantage of some MEMS devices is speed. This is often useful in optical applications, where very small reflecting surfaces can be rapidly adjusted to vary the direction in which incoming light is reflected. One MEMS application, for example, involves a MEMS micro-mirror device having a myriad of very small, independently controllable mirrors to create a visual image for presenting on a display screen. Others use only a single mirror, but are likewise rapidly adjustable and typically quite accurate. Such devices may be used to selectively redirect light, often light from a coherent light source such as a laser. The reflected light may be used in laser printing, or in a raster pattern to produce a visual image on a projection display screen. As should be apparent, in either of these applications it is imperative that the light beam involved be reflected precisely.

Another application for MEMS devices involves data transmission, that is, communications. Information may be sent over a free space channel using a properly modulated light beam. As background, such a system will be generally described with reference to FIG. 1. FIG. 1 is a simplified schematic drawing illustrating selected components of a free space optical communication system 100. Optical transmission system 100 may be part of a much larger communication network having various other wire and wireless channels. The main purpose of system 100, however, is to transfer information from station 105 to station 120. In FIG. 1, station 105 is the transmit station and station 120 the receive station, though in practice each station would typically have both transmission and reception capability. In the housing 107 of station 105 there is shown a light source 109, which produces a modulated optical signal at the direction of transmit controller 104, to which it is connected by cable 108, for carrying the information to be transmitted. The light source 109 is typically a source of coherent light that can be aimed and redirected as necessary without excessive scattering.

Instead of aiming the light directly at the receiver, it has been found advantageous to aim the beam at an adjustable mirror, which reflects the light as appropriate, either toward the receiver or toward other, intermediate optical devices. In the system 100 of FIG. 1, light from light source 109 is aimed at mirror 111, which is an adjustable mirror that redirects the light in the direction of the receive station 120. The propagation path of the light beam is represented by a broken line in FIG. 1. Adjustment of mirror 111, if necessary, may be done manually at installation, or, if connected to an appropriate drive mechanism, such as a motor (not shown), remotely or automatically. Redirection of the light beam is therefore possible without having to move either the light source 109 or the housing 107.

The receive station 120 is represented in FIG. 1 by a housing 122 that contains a target 125, that is, a light beam detector for receiving the signal, and a receiver 130, which in this case will be assumed to demodulate and decode it, based on the information detected by the target 125. The receiver 130 is connected to the target 125 by a cable 127. Note that in most cases, there are many more optical and electrical components at work in this link, but in FIG. 1 these other components are omitted for clarity.

One component that may be employed to improve the quality of the communications system 100 described above is a MEMS micro-mirror. As background to the present invention, such a device will be described with reference to FIG. 2. FIG. 2 is a plan view illustrating selected portions of MEMS micro-mirror device 200. Visible in FIG. 2 is the mirror 201, that is, the portion of the device that may be adjusted to reflect light in an appropriate direction. Mirror 201 has a reflecting surface 203, which may simply be the exterior side of mirror 201, if it is made of a sufficiently reflective material. If not, then reflecting surface 203 refers to the outer surface of whatever material has been added for this purpose, such as a thin metal layer. The mirror 201 is adjustable by rotation about two oppositely disposed torsional hinges 205 and 207 that extend outwardly from mirror 203. Each of these torsional hinges is fixed to the mirror on one end and to a support structure 210 on the other. The support structure 210 is, in turn, attached to a base (not shown) that that holds the support structure and provides for the mechanical and electrical connections to the other elements of transmit station 105. As should be apparent, the support structure 210 must be mounted to the base in such a manner as to permit operation of the mirror 203.

This micro-mirror assembly may be used to advantage in the system described above, for example replacing mirror 111. One impediment to successfully implementing this improvement, however, arises from the nature of the MEMS micro-mirror itself. These micro-mirrors, naturally, are very small, and as noted above they often rotate on relatively fine silicon torsional hinges that permit the mirror to be re-oriented about one or more axes of rotation. Although for this reason these MEMS devices are easily operated by relatively small drive voltages, they are also subject to excess ringing.

Undesirable ringing may occur, for example, when the micro-mirror experiences a physical or electrical shock that initiates harmonic oscillation at the device's resonant frequency. The MEMS micro-mirrors are typically high-Q, that is, they have a high quality resonance factor. This is a desirable property in some applications, where oscillation at the resonant frequency is exploited to, for example, create visual images in projection display systems. In the optical communication system described above, however, a high-Q system resonance characteristic interferes with the communications operations such as data transmission and target acquisition because the system must at times wait for the oscillations to cease. In a high-Q system, by definition, this may take a relatively long time, and the overall system speed may be affected. This may be a problem especially in an application where an optical communication system is used to transmit data at high transmission rates. The undesirable oscillation may also increase the data transmission error rate, slowing the system by requiring significant retransmission even where the basic transmission speed remains unaltered.

It would be an advantage, therefore, if a MEMS scanning system for use in, for example, an optical communications network, could be fabricated such that undesirable ringing of the micro-mirror, especially following some type of unavoidable shock event, could be reduced or eliminated. The present invention provides just such a solution.

### SUMMARY OF THE INVENTION

The excessive ringing effect described above and other problems are generally solved or circumvented, and technical advantages are generally achieved, by preferred embodiments of the present invention, in which a MEMS scanning is constructed using a MEMS micro-mirror device having a micro-mirror operable to rotate on torsional hinges. At least one, and preferably all of the torsional hinges are operationally attached to an elastomer that suppresses oscillations at the system's resonant frequency.

In accordance with a preferred embodiment of the present invention, a system method for fabricating a MEMS scanning system comprises providing a wafer substrate to serve as a micro-mirror layer, forming a torsional hinged micro-mirror by removing certain selected portions of the substrate, mounting the substrate onto a base unit, and forming one or more elastomer elements operationally affixed, respectively to one or more of the torsional hinges.

In this preferred embodiment, the micro-mirror and base unit is then mounted in a housing along with a coherent light source to form the scanning system. This method may also include using the light source and micro-mirror device having elastomer-damped hinges to execute a scan to locate a receive station target, and to communicate information to the receive station on a free space optical channel.

In accordance with another preferred embodiment of the present invention, a MEMS scanning system comprising a micro-mirror element having a reflective surface, the micro-mirror being supported by a plurality of integrally formed torsional hinges about which the micro-mirror may rotate to alter the orientation of the reflective surface. In this embodiment, at least one and preferably all of the torsional hinges are operationally affixed to an elastomer element. In a preferred embodiment, two torsional hinges to gimbals support the micro-mirror element, which is in turn supported by two torsional hinges to a support structure. In this embodiment, the mirror hinges and the gimbals hinges define two orthogonal axes of rotation and are each associated with an elastomer element.

In another embodiment, the present invention is directed to a MEMS scanning system using free space optical transmission to transmit a high data rate communication signal. The MEMS scanning system includes a coherent light source such as a laser that may be modulated to transmit information over a line-of-sight communication channel. The laser is mounted in a housing, and may be adjustable, is generally not designed to move appreciably during system operation. In order to accommodate changing conditions, however, and possibly the shifting in position of either the transmitter or the receiver, a MEMS scanning mirror is employed.

This MEMS scanning mirror is operable to rotate about at least one, and preferably two axes of rotation. In one embodiment, the rotation occurs about one or more, and preferably two torsional hinges that are integrally formed with the mirror, one each of two opposing sides. To achieve two-axis rotation, the torsional hinges fixed to the mirror at one end are fixed, and preferably integrally formed with gimbals at the other. The gimbals are similarly rotatable about a second axis, for example one that is orthogonal to the first. The second set of torsional hinges is fixed to a support structure that, in turn is preferable fixed to the same housing as the coherent light source. Each of the torsional hinges is associated with an elastomer element to which it is operationally attached.

The coherent light from the laser is aimed at the reflecting surface of the MEMS mirror, which is operable to redirect the light depending on the orientation of the light from the mirror surface. The housing, and therefore the components mounted to it, are of course mounted in such a manner as to direct the reflected light toward the target that is the communications receiver, as nearly as possible.

A more complete appreciation of the present invention and the scope thereof can be obtained from the accompanying drawings that are briefly summarized below, the following detailed description of the presently preferred embodiments of the present invention, and the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a simplified schematic drawing illustrating selected components of a free space optical communication system.

FIG. 2 is a plan view illustrating selected portions of the MEMS micro-mirror device in the optical communication system of FIG. 1.

FIG. 3 is a simplified schematic drawing illustrating selected components of a free space optical communication system constructed according to an embodiment of the present invention.

FIG. 4 is an isometric view of the two-axis MEMS micro-mirror device shown in FIG. 3, and fabricated according to an embodiment of the present invention.

FIG. 5 is an isometric view of micro-mirror layer according to an embodiment of the present invention.

FIG. 6 is an isometric view illustrating a selected portion of a MEMS device fabricated according to an embodiment of the present invention.

FIG. 7 is a flow diagram illustrating a method of fabricating a MEMS device according to an embodiment of the present invention

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a MEMS scanning system using coherent light reflected off a micro-mirror in an optical communications. The invention may also be applied, however, to other MEMS devises as well.

The present invention, then, is directed to embodiments of a MEMS design, and to a method for manufacturing this system. The innovative application of an elastomer element to selected portions of the MEMS micro-mirror device will, in most cases, damp undesirable ringing at resonant frequencies, while at the same time permitting the movement necessary for operation of the device. This helps to make the micro-mirror more suitable for integration into, for example, a MEMS scanning system for a high-speed data link. Note, however, that the present invention is drawn to the various embodiments of this inventive concept, and no particular result or level of performance is required unless explicitly claimed. In addition, the description of embodiments herein is intended to be illustrative rather than limiting. Other embodiments, as well as variations on those described here, are considered in accord with the spirit of the invention and not excluded from the scope of the claims simply because they are not specifically described.

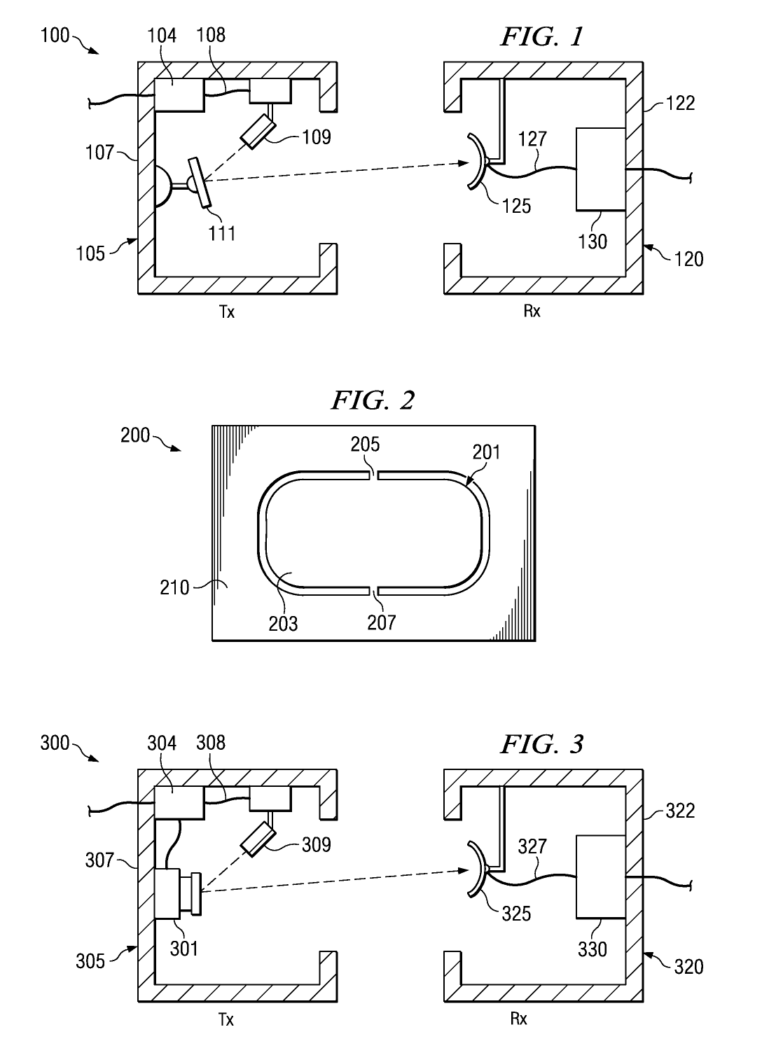

In one embodiment, the present invention is a MEMS scanning system, such as may be found in an optical communication network transmission node, the system employing a MEMS micro-mirror device having elastomer-damped hinges. Augmented in this fashion, a micro-mirror such as the one illustrated in FIG. 2 may be used in a MEMS scanning system such as the one illustrated in FIG. 1. A similar though not identical configuration is presented in FIG. 3. FIG. 3 is a simplified schematic drawing illustrating selected components of a free space optical communication system 300 constructed according to an embodiment of the present invention. As should be apparent, the significant distinction from the system 100 of FIG. 1 is that a MEMS micro-mirror device 301 is employed used in place of mirror 111. (In another embodiment (not shown), both may instead be used, in series.) The use of a MEMS micro-mirror in this system offers many advantages, as described above, although these advantages are diminished when excess ringing occurs. Constructed according to an embodiment of the present invention, however, system 300 with micro-mirror device 301 permits the use of this advantageous configuration while at the same time minimizing the performance degrading ringing that might otherwise occur. Note that communication system 300 is similar, though not necessarily identical to the communication system 100 of FIG. 1. Similar components are, however, numbered analogously and will not be further described here.

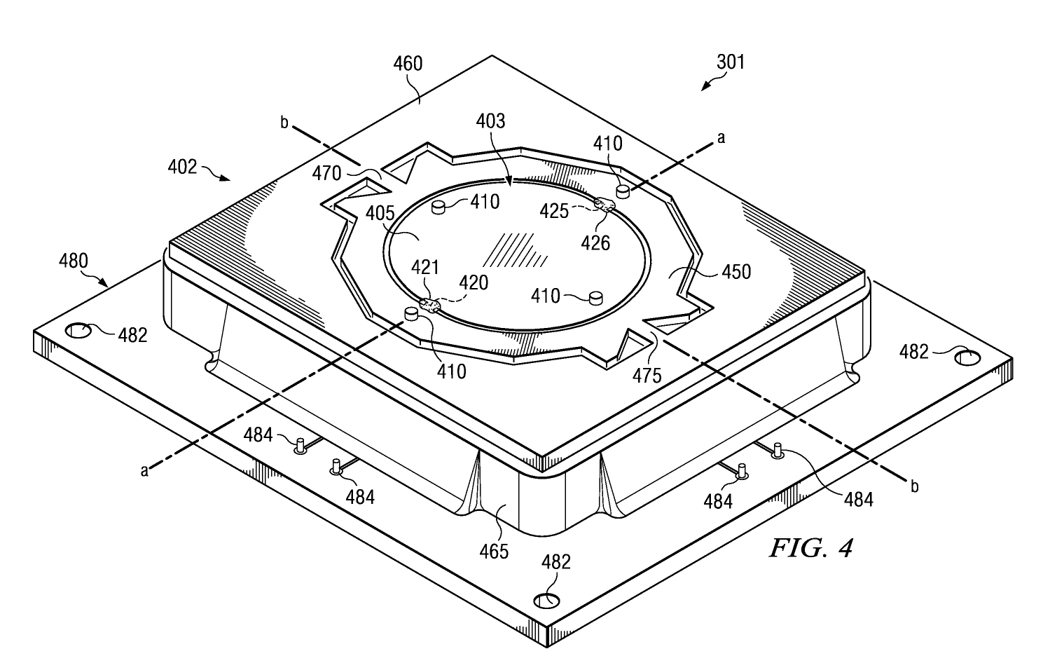

In a preferred embodiment of the present invention, a two-axis MEMS micro-mirror device is used because it enables greater flexibility in mirror re-orientation (although a single-axis device, such as the one shown in FIG. 2, could be modified in accordance with the present invention and used as well). FIG. 4 is an isometric view of the two-axis MEMS micro-mirror device 301 shown in FIG. 3, and fabricated according to an embodiment of the present invention. The micro-mirror device 301 includes a micro-mirror 403 an active surface 405, in this embodiment formed of a reflective material such as gold or another reflective metal. As mentioned above, it is this active surface 405 that reflects the incident laser light, for example in communication system 300, toward a receiver target. The direction of the reflected beam is altered by adjusting the orientation of the micro-mirror 403 and its active surface 405.

The orientation of the micro-mirror 403, including active surface 405, is controlled by drive circuitry (not shown in FIG. 4) that includes a controller, a power source, and a drive mechanism. In this embodiment, the controller and power source for the MEMS device may be the same as those generally used for operating the communications system of which the MEMS device is an integral component, although a separate power supply or controller may be used as well. The drive mechanism in this embodiment includes a plurality of permanent magnets 410 that are generally disposed about the active surface 405. (Four magnets are visible in FIG. 4; any that may be present but hidden in this view are for clarity not represented.) Each of permanent magnets 410 is selectively attracted or repelled by activating a coil (not shown but located under the mirror and hidden in this view) via the control circuitry under the direction of the controller, and causing the mirror 403 or mirror and gimbals 450 to change orientation.

Micro-mirror 403 is, in this embodiment, supported by two torsional hinges 420 and 425. Rotation about axis a-a is thereby enabled to a limited extent. The limits of rotation may arise because of the limits of the coils to carry current, which, in turn, limits the torque produced on the magnets. The current limited torque is unable to deform the torsional hinges past a certain extent of deformation. Limits of rotation may also arise due to the limited ability of the control circuitry to source current to the coil. Other structural limits may be used as well, though they are not illustrated in the embodiment of FIG. 4. Despite whatever limitations are imposed, however, sufficient torsional deformation is enabled that the MEMS device may be used for its intended purpose. That is, the micro-mirror 403 may be oriented so as to direct the light beam in any, or almost any direction as needed for the beam to reach the receiver target.

Of course, the torsional hinges 420 and 425 permit reorientation only about axis a-a. As mentioned to above, in some MEMS applications this may be sufficient. For example, where scanning motion is only required in one direction. In other systems, a second one-axis micro-mirror device may be used in series with a first to further redirect the propagating light beam. The light source itself may, of course, also be adjustable. In many systems, however, a two-axis mirror is used to redirect the incident light in any direction allowed within the limits of rotation as described above. In other words, where a one-axis micro-mirror will serve the intended function, there is no need for the somewhat more complicated design of the two-axis micro-mirror of FIG. 4. Note that the present invention may be used in either case.

In many, if not most MEMS scanning systems, however, the two-axis micro-mirror of FIG. 4, or a similar design, is preferred. In the two-axis micro-mirror, rotation about the second axis b-b is facilitated by gimbals 450. Gimbals 450 are preferably formed at the same time as the mirror itself is formed, and have the same material. It is generally overlaid with reflective material as well, often at the same time as reflective surface 405 is formed, but in some embodiments it need not be. The gimbals 450 is permitted to rotate on torsional hinges 470 and 475, which define axis b-b. In the embodiment of FIG. 4, axis b-b is orthogonal to axis a-a, as is generally though not necessarily the case. As hinges 420 and 425 extend between the micro-mirror 403 and the gimbals 450, and hinges 470 and 475 extend between the gimbals 450 and support structure 460, the mirror plane may be adjusted to any orientation within system limits. Note that the support structure may actually include a number of component members, which may or may not be attached to each other.

In the embodiment of FIG. 4, the rotation of gimbals 450 is governed largely by permanent magnets 410. It is noted that both the micro-mirror 403 and the gimbals 450 are generally, in operation, most influenced by the permanent magnets 410 that are disposed furthest from their respective hinges. The individual permanent magnets are, of course, cooperatively attracted and repelled by current in the drive coils provided by the drive circuitry to produce the desired active surface orientation. Other drive configurations may also be used. Permanent magnets 410, for example, may be replaced by ferromagnetic metal drive elements that, in operation, will be attracted or repelled to electromagnets positioned elsewhere.

The support structure 460 is, in this embodiment, mounted on a base 465, which preferably holds the support structure 460 in a fixed position with respect to the base plate 480. Base 465 may be formed in any useful configuration, although it must be formed so as to allow the micro-mirror 403 and gimbals 450 to operate within their desired ranges. Base plate 480 is securely attached to base 465, and may be used for mounting the entire device 301 to, for example, a housing such as the housing 307 shown in FIG. 3. Mounting openings 482 are formed for this purpose. In FIG. 4, connection leads 484 are also illustrated, including a conductive trace leading from each of them to base 465. (The connections made inside base 465 are not shown.) These leads are one manner of making the necessary power and control connections to the remainder of the system.

As mentioned above, precise orientation of the active surface is important, and often critical to proper system operation. Excessive ringing caused by electrical or mechanical shock may seriously detract from the ability of the MEMS device to provide the requisite level of precision. In accordance with an embodiment of the present invention, undesirable ringing is significantly damped by the application of an elastomer element to a selected portion of the MEMS device 301.

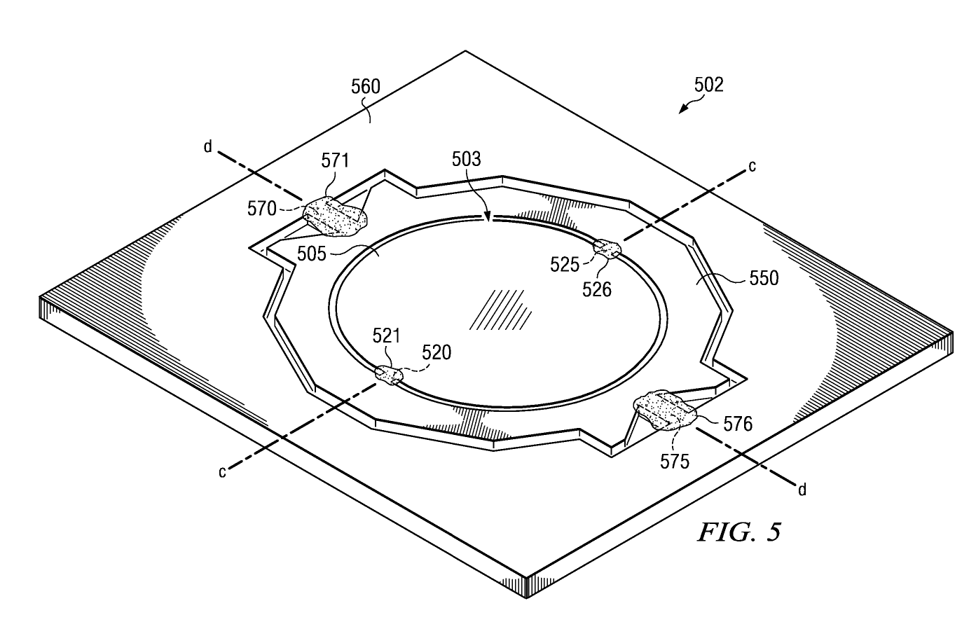

In the embodiment of FIG. 4, elastomer elements 421 and 426 have been applied to torsional hinges 420 and 425, respectively. As should be apparent, elastomer elements 421 and 426 primarily effect the rotational deformation of torsional hinges 420 and 425, but will not have a significant impact on the rotation about torsional hinges 470 and 475. In some embodiments, this configuration may be intentionally used. In others, the elastomer element may be applied to only a single one of torsional hinges 420 and 425. In general, however, it is presently preferred that an elastomer element is applied to all four of the torsional hinges that are present in this embodiment. FIG. 5 illustrates this configuration.

FIG. 5 is an isometric view of micro-mirror layer 502 according to an embodiment of the present invention. Note that micro-mirror layer 502 is similar though not identical to micro-mirror layer 402 shown in FIG. 4. Note also that the drawings herein are not intended to be to scale, but rather certain features, for example the torsional hinges shown in FIG. 5, are exaggerated for purposes of illustration. The micro-mirror 503 has a reflective surface 505, which may be a separate layer of reflective material and that may or may not cover the entire coplanar surface of micro-mirror layer 502. Micro-mirror 503 is supported by torsional hinges 520 and 525 and is operable to rotate about the axis c - c defined by them. Torsional hinges 520 and 525 connect micro-mirror 503 to a mirror support structure, in these embodiment gimbals 550, from which it is otherwise completely separated. Similarly, gimbals 550 are supported by torsional hinges 570 and 575 and are operable to rotate about the axis d - d defined by them. Torsional hinges 570 and 575 connect micro-mirror 503 to support structure 560, from which it is otherwise completely separated.

The micro-mirror 503 is therefore able to reorient the active surface 505 up to the limits of torsional deformation of the respective torsional hinges. Here, it should be noted that while in operation the primary deformation of the hinges is torsional, a small amount of lateral or longitudinal deformation might also occur. This effect is ignored for purposes of describing the present invention.

In accordance with an embodiment of the present invention, elastomer element 521 is applied to torsional hinges 520, and elastomer element 526 is applied to torsional hinge 525. This means, in effect, that an elastomer element has been added adjacent to each of these hinges. As used here, “adjacent” does not necessarily mean immediately adjacent where, for example, an intermediate coating is first added before the elastomer is applied. Where a reflective layer is formed on the surface of micro-mirror and also covers all or part of a torsional hinge, an elastomer element applied on or partly on the reflective material is still considered adjacent to the hinge itself. Of course, the elastomer element remains near enough to the hinge as it operates to obtain the advantages of the present invention. The elastomer element may cover only the top of the hinge (the top being to the fore of the view of FIG. 5), or it may cover the sides and bottom of the hinge as well. In this case, there is no requirement that the elastomer coverage be uniform about the entire hinge. In describing this relationship between a torsional hinge and an elastomer element, the two will be said to be “operationally affixed” to each other.

As can more clearly be seen in FIG. 5 with elastomer elements 571 and 576, which are applied to torsional hinges 570 and 575, respectively, the elastomer element can also cover a portion of either structure adjacent to the hinge. For example, elastomer element 576 covers (and therefore is adjacent to) a portion of gimbals 550 and of support structure 560 that are near torsional hinge 575. In some embodiments (not shown), steps may be taken to ensure that the elastomer element does not lie adjacent to any structure except the hinge itself, or covers only a portion of the hinge. This may be accomplished, for example, by erecting removable dams prior to applying the elastomer, or by applying the elastomer prior to forming the micro-mirror and gimbals in layer 502, or simply by limiting the amount of elastomer applied. In some embodiments, more than one elastomer element may be associated with a single torsional hinge, although this is not presently preferred.

In operation, the elastomer elements are expected to have a damping effect upon any resonant-frequency oscillation that happens to be induced in the micro-mirror components (although again, no particular result is required unless explicitly recited). As should be apparent, this means that any such oscillation will subside more quickly and the MEMS device may return to normal operation more quickly after an inducing event. This, in turn, is expected to improve system performance. Note that for this effect to occur, the elastomer does not have to be applied to all of the hinges in a single system, or to all of the hinges in the same manner or to the same extent, but doing so is presently preferred.

In addition, there is no particular method of elastomer application that is required unless explicitly recited. In different embodiments, however, the elastomer may be dripped or brushed on. It may also be applied to the entire surface and then selectively removed to leave elastomer elements only where specifically desired. The elastomer may be applied in liquid form, or in solid form and then heated to assure proper coverage and adhesion. Note that the elastomer will normally adhere to the surface to which it is applied, but an adhesive material may be used as well to hold it in place adjacent to the hinge so that it is not dislodged over time by operation of the micro-mirror device. A cure process, if necessary, may also assist in properly forming the elastomer elements and retaining them in position.

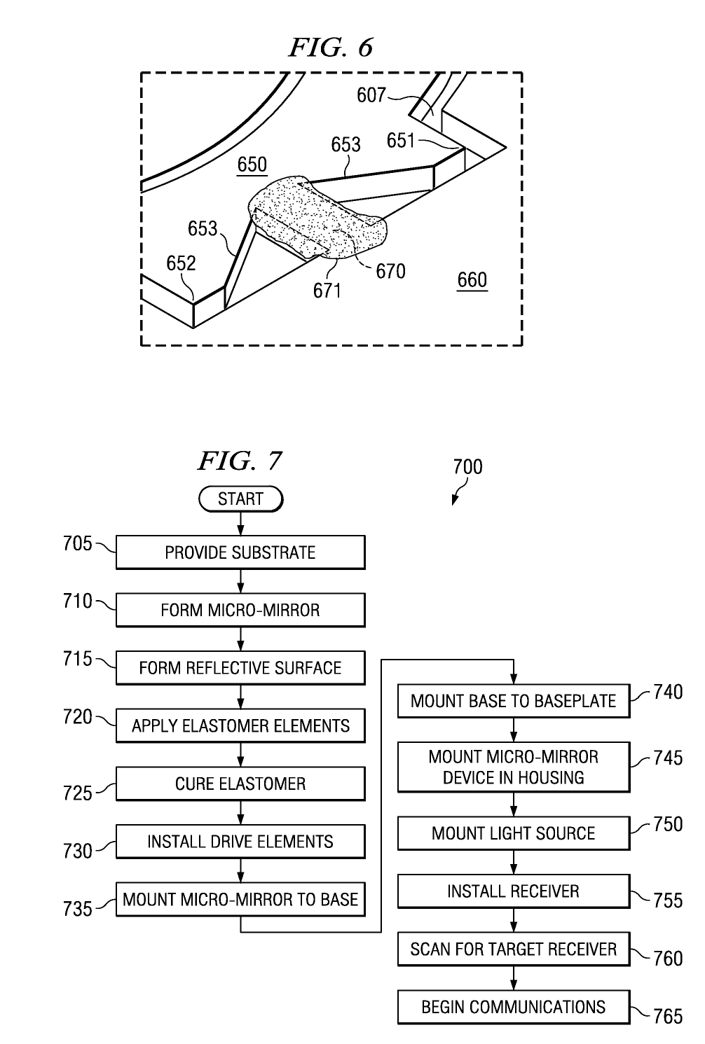

FIG. 6 is an isometric view illustrating a selected portion of a MEMS device fabricated according to an embodiment of the present invention. In this view, one end of a MEMS device gimbals 650 is connected to support structure 660 by torsional hinge 670, which spans the recess 607 that otherwise separates them. In a preferred embodiment, gimbals 650, hinge 670, and support structure 660 is integrally connected, being formed into the illustrated configuration by the formation of recess 607. An elastomer element 671 extends along the entire length of torsional hinge 670, and part of the way down each side into recess 607 (meaning, of course, that it was in this embodiment formed after recess 607). To some extent, elastomer element 671 also extends onto the respective surfaces of both gimbals 650 and support structure 660 as well. Note also that in this embodiment, the torsional hinge 670 to which elastomer element 671 has been applied extends beyond the edge (as defined by comers 651 and 652) of gimbals 650 for only a relatively small portion of its length; the remainder of its length runs through the recess created by recessed edge portion 653 of gimbals 650. This is presently considered an advantageous configuration.

FIG. 7 is a flow diagram illustrating a method 700 of fabricating a MEMS device according to an embodiment of the present invention. At START it is assumed that the materials and equipment necessary for performing method 700 are available and operational. The process then begins with the provision of a substrate (step 705). The substrate is typically a thin piece, or wafer of material such as silicon on which certain operational components will be formed or situated. In some cases, a large wafer substrate will be used to make a number of devices at the same time. The individual devices are then separated form each other at some point in the fabrication process. In other cases, a wafer substrate that is appropriately sized for a single device is provided instead.

In the embodiment of FIG. 7, the micro-mirror is formed (step 710). This may be done, for example, by depositing and patterning a photoresist layer, and then using an etching process to form the long, narrow recess though the substrate, separating the micro-mirror from the substrate except for the narrow members that then form the micro-mirror torsional hinges (refer, for example, to FIGS. 4 and 5). If gimbals are part of the design, it may also be formed at this time in similar fashion (usually in the same processing step). The photoresist may then be removed. Other procedures for forming the micro-mirror may be used as well.

In this embodiment, a reflective coating is then formed (step 715) over substantially the entire substrate. This reflective material serves to provide the reflective surface for reflecting light, for example the coherent light beam in the optical communication system of FIG. 3. In an alternate embodiment, the reflective layer is added only to a selection portion of the substrate, such as the micro-mirror itself. In another alternate embodiment, the substrate itself is made of a sufficiently reflective material such that an additional reflective layer is not required. In the present embodiment, however, the substrate is silicon and the reflective layer added in step 715 is a reflective metal layer. Other reflective materials may be used as well. If necessary, the reflective layer (or, if applicable, the substrate itself) is clean, polished, or otherwise treated (step not shown) to improve its reflective characteristics.

The elastomer elements may now be formed (step 720). The hinges to which the elastomer is applied, and the extent of the application, are determined by system design considerations. In the presently preferred embodiment, elastomer is applied to each of the micro-mirror hinges and each of the gimbals hinges (see FIG. 5). The elastomer material, in one embodiment, silicone, is applied while in a liquid state to the torsional hinge area, for example by dropping or brushing. Note, however, that no specific level of viscosity is required. In other embodiments, the elastomer member may also be applied in a solid state and, if necessary, made to conform or to adhere to the hinge (or both) by the application of heat or pressure. In liquid form, the elastomer member will tend to spread around the torsional hinge and onto a portion of the adjacent structures. In the presently preferred embodiment, this is not only acceptable but also desirable. The elastomer is then cured (step 725) as necessary to take on a more resilient character. A special curing environment may or may not be required. The permanent magnets or other micro-mirror drive elements may then be installed (step 730), as is necessary with the particular embodiment being fabricated.

The micro-mirror is then mounted on a base (step 735). As mentioned above, this mounting may be accomplished in any manner that holds the components securely together, such as by use of an adhesive, without interfering with micro-mirror operation. Any necessary electrical connections may also be made as part of this process. The base is then mounted onto a base plate (step 740) in similar fashion, again, making whatever structural and electrical connections are necessary. The base and the base plate may be collectively referred to as a “base unit”, which in other embodiments may have more or less than two components. In particular, connections to the drive circuitry are made at this time (or at least the relevant portion of it; in some embodiments, some of the drive circuitry may be located on the system housing; see FIG. 3, for example).

The MEMS micro-mirror device may then be installed (step 745) in a housing as, for example, in the system of FIG. 3. The housing there is only exemplary, of course, and any suitable mounting structure may be used. As part of this step, the necessary power and control connections are made. A light source is then mounted (step 750), aimed generally at the micro-mirror (unless other, intervening optics are employed, as may be the case). The presence of a controller for directing the operation of the light source and micro-mirror is assumed. A receive station may then also be installed (step 755) at a predetermined location.

When the equipment is ready, a scan may be performed (step 760) in order to properly aim the propagating light beam. That is, a locate signal may be sent out bearing a test sequence that will be recognized by the receive station. The direction of this transmission changes according to a predetermined pattern until the receiver is located. When the receiver does receive the test sequence, it notifies the transmit station. If a direction indicator is included within the test sequence, it may be returned with the notification message. In this way, the sweep may be done quickly without having to stop at each position to wait for a potential notification message. When the micro-mirror is oriented correctly, communications may begin (step 765). Although not shown in FIG. 7, the system may also perform additional scans and re-orient the micro-mirror as necessary. This may be done periodically or upon receipt of an alarm or customer request.

Finally, it is noted that the sequence presented above is just one embodiment. Others are possible, and the steps of method 700 may be performed in any logically permissible order unless specified otherwise. Many of the individual components, for example, may be formed or assembled in a variety of sequences.

Although the present invention and its advantages have been described in detail, it should be understood that various changes, substitutions and alterations can be made herein without departing from the spirit and scope of the invention as defined by the appended claims. For example, it will be readily understood by those skilled in the art that the materials used for the elastomer elements, and the methods or patterns by which they are applied to the torsional hinges, may be varied while remaining within the scope of the present invention. By the some token the present invention certainly has applicability outside of the application of communications described above.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A micro-electromechanical system (MEMS) scanning system, comprising:
a mirror element having a reflective surface;
a plurality of torsional mirror hinges connected to the mirror element and defining an axis about which the mirror rotates as the reflective surface changes orientation; and
at least one elastometric element operationally affixed to one of the torsional hinges.

2. The MEMS scanning system of claim 1, wherein the torsional mirror hinges are integrally formed with the mirror element.

3. The MEMS scanning system of claim 1, wherein each of the plurality of torsional mirror hinges operationally affixed to a respective elastomer element.

4. The MEMS scanning system of claim 1, wherein the elastomer element comprises silicone material.

5. The MEMS scanning system of claim 1, further comprising a mirror support structure connected to at least one of the torsional mirror hinges.

6. The MEMS scanning system of claim 5, wherein the mirror support structure is connected to each of the plurality of torsional mirror hinges.

7. The MEMS scanning system of claim 6, wherein the mirror support structure is integrally formed with the plurality of torsional mirror hinges.

8. The MEMS scanning system of claim 7, wherein each of the plurality of torsional mirror hinges is treated with an applied elastomer.

9. The MEMS scanning system of claim 5, wherein the mirror support structure is gimbals.

10. The MEMS scanning system of claim 9, further comprising a plurality of torsional gimbals hinges and defining an axis about which the gimbals rotates as it changes orientation.

11. The MEMS scanning system of claim 10, wherein each of the plurality of torsional gimbals hinges is treated with an applied elastomer.

12. The MEMS scanning system of claim 1, further comprising a light source.

13. The MEMS scanning system of claim 12, wherein the light source is a coherent light source.

14. The MEMS scanning system of claim 13, wherein the MEMS scanning system is an optical communications system.

15. A method for fabricating a MEMS scanning system, comprising:
forming a torsional-hinged micro-mirror in a substrate layer;
mounting the substrate layer onto a base unit; and
applying an elastomer material to at least one torsional hinge.

16. The method of claim 15, wherein the elastomer material is applied to all torsional hinges associated with the micro-mirror.

17. The method of claim 15, further comprising curing the elastomer material.

18. The method of claim 15, further comprising mounting the base unit in a communication network transmit station.

19. The method of claim 18, further comprising operating the micro-mirror to reflect light from a light source in a predetermined scanning pattern in an attempt to locate a communication network receive station.

20. A scanning system, comprising:
a coherent light source;
a micro-mirror operable to rotate about at least one set of torsional hinges to reflect light received from the coherent light source at a plurality of angles; and
an elastomer damping structure applied to at least one of the torsional hinges in the set.
